(19) United States
(12) Patent Application Publication
(10) Pub. No.: US 2024/0424934 A1
(43) Pub. Date: Dec. 26, 2024

(54) Flow Battery Mechanization and Control Topology

(71) Applicant: The Noco Company, Glenwillow, OH (US)

(72) Inventors: John Derek Williams, Anthem, AZ (US); Andrea Carolina Hacker Davidson, Phoenix, AZ (US); James P. McBride, Phoenix, AZ (US); Travers Kenton Buda, Tempe, AZ (US)

(21) Appl. No.: 18/746,139

(22) Filed: Jun. 18, 2024

Related U.S. Application Data
(60) Provisional application No. 63/509,547, filed on Jun. 22, 2023.

(51) Int. Cl. B60L 53/54; B60L 53/62; H01M 8/18; H02M 3/158

(52) U.S. Cl. CPC B60L 53/54; B60L 53/62; H01M 8/188; H02M 3/1584; B60L 2210/12; B60L 2210/14

(57) ABSTRACT

Embodiments disclosed herein include an electric vehicle charging system comprising an electrolyte flow system including an anolyte tank having an anolyte solution and a catholyte tank having a catholyte solution. A core stack circuit may be coupled to the electrolyte flow system that is configured to receive the anolyte and catholyte solutions and generate a core stack output voltage and current based on flowrates of the anolyte and catholyte solutions. The EV charging system may further include a DC/DC converter that is configured to receive the core stack output voltage and buck or boost the core stack output voltage based on the core stack output voltage and a charging voltage of an EV. The flowrates of the anolyte and catholyte solutions may be controlled based on a charging voltage of the EV and the core stack output voltage, which can reduce a buck or boost ratio of the DC/DC converter.

### CROSS-REFERENCE TO RELATED APPLICATIONS

This application claims the benefit of priority to U.S. Provisional Patent Application No. 63/509,547, filed Jun. 22, 2023, which is incorporated herein by reference in its entirety.

### FIELD

The present disclosure relates to electric chargers, and in particular to chargers for electric vehicles.

### BACKGROUND

Electric vehicles (EVs) have grown in use around the world with a strong interest in clean emissions, quiet driving, and low maintenance. Certain systems for charging EVs, such as those employing lithium-ion battery power reservoirs, may limit storage voltage to reduce large termination equivalent series resistance (ESR) losses that can be present in large battery pack arrays. Thus, DC/DC converters having relatively high buck or boost ratios (e.g., the ratio between the voltage at an output side of the DC/DC converter and the voltage at an input side of the DC/DC converter) may be implemented in certain charging systems to increase the voltage within the power reservoir to a charging voltage required by the EV battery pack. As the buck or boost ratios of the DC/DC converter increase, the efficiency of the charging system may decrease. Furthermore, some power reservoirs may require close spatial proximity to a charging head of an electrical vehicle charging cord (e.g., close spatial proximity to the EV they are charging) because of the voltage drop present in high-voltage DC links. In addition, some power reservoirs, such as lithium-ion batteries, may also experience self-discharging due to spontaneous internal chemical reactions. Therefore, there is a need in the art for EV charging systems and methods that mitigate or eliminate the inefficiencies associated with DC/DC converters having high buck or boost ratios, the need for power reservoirs to be close to the EV they are charging, and the self-discharging due to spontaneous chemical reactions.

### SUMMARY

The present disclosure includes an example embodiment of an electric vehicle (EV) charging system. The EV charging system may comprise an electrolyte flow system including an anolyte tank having an anolyte solution and a catholyte tank having a catholyte solution. The EV charging system may be configured to control a flow rate of the anolyte solution and the catholyte solution. The EV charging system may further include a core stack circuit coupled to the electrolyte flow system. The core stack circuit may comprise a plurality of flow battery core stacks configured to receive the anolyte solution and the catholyte solution and to generate a flow battery core stack output voltage and current based on the flow rates of the anolyte solution and the catholyte solution. Each flow battery core stack may be selectively connected or disconnected to one another. The selective connection or disconnection of each flow battery core stack may coarsely tune an EV charging voltage.

The EV charging system may further include a DC/DC converter module comprising a plurality of DC/DC converters. The DC/DC converter module may be coupled to the core stack circuit and configured to receive the flow battery core stack output voltage and current. The DC/DC converter module may be further configured to buck or boost the flow battery core stack output voltage based on the EV charging voltage. The bucking or boosting of the flow battery core stack output voltage may finely tune the EV charging voltage.

In some embodiments, each flow battery core stack comprises a plurality of flow battery cells connected together in series. Each of the DC/DC converters may be selectively coupled to one another in parallel based on a buck ratio or a boost ratio of the DC/DC converter module. The EV charging system may be configured to charge the EV at one of a plurality of charging speeds. The buck ratio or the boost ratio may be determined based on a selected charging speed of the EV charging system. The EV charging system may further comprise a control module configured to selectively connect one or more flow battery core stacks to one another based on a required input voltage of the DC/DC converter module. The EV charging system may further comprise one or more relays coupled to the control module. The control module may selectively connect the one or more flow battery core stacks to one another based on opening or closing the one or more relays.

In another example embodiment, an EV charging system comprises an electrolyte flow system including an anolyte tank having an anolyte solution and a catholyte tank having a catholyte solution. The EV charging system may further include a core stack circuit coupled to the electrolyte flow system. The core stack circuit may be configured to receive the anolyte solution and the catholyte solution and to generate a core stack output voltage and current based on a flow rate of the anolyte solution and a flow rate of the catholyte solution. The EV charging system may further include a DC/DC converter coupled to the core stack circuit that is configured to receive the core stack output voltage and to buck or boost the core stack output voltage based on the core stack output voltage and a charging voltage of an EV. The EV charging system may be configured to control the flow rates of the anolyte solution and the catholyte solution based on a charging voltage of the EV and the core stack output voltage. The controlling of the flow rates may reduce a buck ratio or a boost ratio of the DC/DC converter.

The core stack circuit may comprise a plurality of flow battery cells connected together in series. The core stack circuit may receive the anolyte solution at a positive end of each flow battery cell and the catholyte solution at a negative end of each flow battery cell. The EV charging system may further comprise a plurality of flow battery core stacks, wherein the EV charging system is configured to connect or disconnect each of the flow battery core stacks to each other based on the charging voltage of the EV. The EV charging system may further comprise a power output module coupled to the DC/DC converter. The power output module may be configured to control the boost ratio or the buck ratio of the DC/DC converter. The EV charging system may further comprise a throttle power control module coupled to the electrolyte flow system. The throttle power control module may be further configured to control the flow rate of the anolyte solution and the flow rate of the catholyte solution. The EV charging system may further include a control module coupled to the power output module and the throttle power control module. The control module may be configured to adjust the flow rate of the anolyte solution and the catholyte solution based on one or more parameters of the DC/DC converter and the charging voltage of the EV.

In another example embodiment, a method of charging an EV comprises receiving an anolyte solution and a catholyte solution at a core stack circuit comprising a plurality of flow battery core stacks. The method may further include selectively connecting or disconnecting each of the flow battery core stacks to each other based on a charging voltage of the EV. The core stack circuit may be capable of generating a core stack output voltage within a core stack voltage variability range based on the selective connection or disconnection of the flow battery core stacks. The method may further include controlling a flow rate of the anolyte and catholyte solutions. The method may further include generating the core stack output voltage and a core stack output current based on the flow rates of the anolyte solution and the catholyte solution and the selective connection or disconnection of the flow battery core stacks. The core stack output voltage and the core stack output current may form an optimized operating point.

The method may further include bucking or boosting the core stack output voltage based on the core stack output voltage and the charging voltage of the EV. The control of the flow rates of the anolyte and catholyte solution may be determined by a proportional-integral-derivative (PID) controller. The EV may include a plurality of charging speeds. The method may further include controlling a charging current of the EV based on a selected one of the plurality of charging speeds. The method may further comprise referencing a look-up table to determine the charging voltage of the EV based on the selected charging speed of the EV. The method may further comprise accumulating the anolyte solution and the catholyte solution after the anolyte solution and the catholyte solution are used to charge the EV. The selective disconnection of each of the flow battery core stacks may be further based on an additional voltage allocation required for conditioning and control by a DC/DC converter module.

### BRIEF DESCRIPTION OF THE DRAWINGS

The following detailed description will be better understood when read in conjunction with the appended drawings. For the purpose of illustration, there is shown in the drawings certain embodiments of the present disclosure. It should be understood, however, that the invention is not limited to the precise arrangements and instrumentalities shown. The accompanying drawings, which are incorporated in and constitute a part of this specification, illustrate an implementation of systems and apparatuses consistent with the present invention and, together with the description, serve to explain advantages and principles consistent with the invention.

FIG. 1A depicts a diagram of an electric vehicle charging system coupled to a utility power grid, in accordance with some embodiments.

FIG. 1B depicts a diagram of an electric vehicle charging system, in accordance with some embodiments.

FIG. 2A depicts a detailed diagram of an electric vehicle charging system, in accordance with some embodiments.

FIG. 2B depicts an idealized flow battery parameter diagram, in accordance with some embodiments.

FIG. 2C depicts an electric vehicle charging system operating at a decreased current and voltage capacity, in accordance with some embodiments.

FIG. 3 depicts a detailed diagram of an electric vehicle charging system having a plurality of flow battery core stacks and a plurality of DC/DC converter modules, in accordance with some embodiments.

FIG. 4 depicts an example core stack circuit, in accordance with some embodiments.

FIG. 5 depicts a core stack circuit and a DC/DC stack circuit, in accordance with some embodiments.

FIG. 6 depicts a method of charging an electric vehicle, in accordance with some embodiments.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

It is to be understood that the phraseology and terminology employed herein are for the purpose of description and should not be regarded as limiting. For example, the use of a singular term, such as, “a” is not intended as limiting of the number of items. Also the use of relational terms, such as but not limited to, “top,” “bottom,” “left,” “right,” “upper,” “lower,” “down,” “up,” “side,” are used in the description for clarity and are not intended to limit the scope of the invention or the appended claims. Further, it should be understood that any one of the features can be used separately or in combination with other features. Other systems, methods, features, and advantages of the invention will be or become apparent to one with skill in the art upon examination of the detailed description. It is intended that all such additional systems, methods, features, and advantages be included within this description, be within the scope of the present invention, and be protected by the accompanying claims.

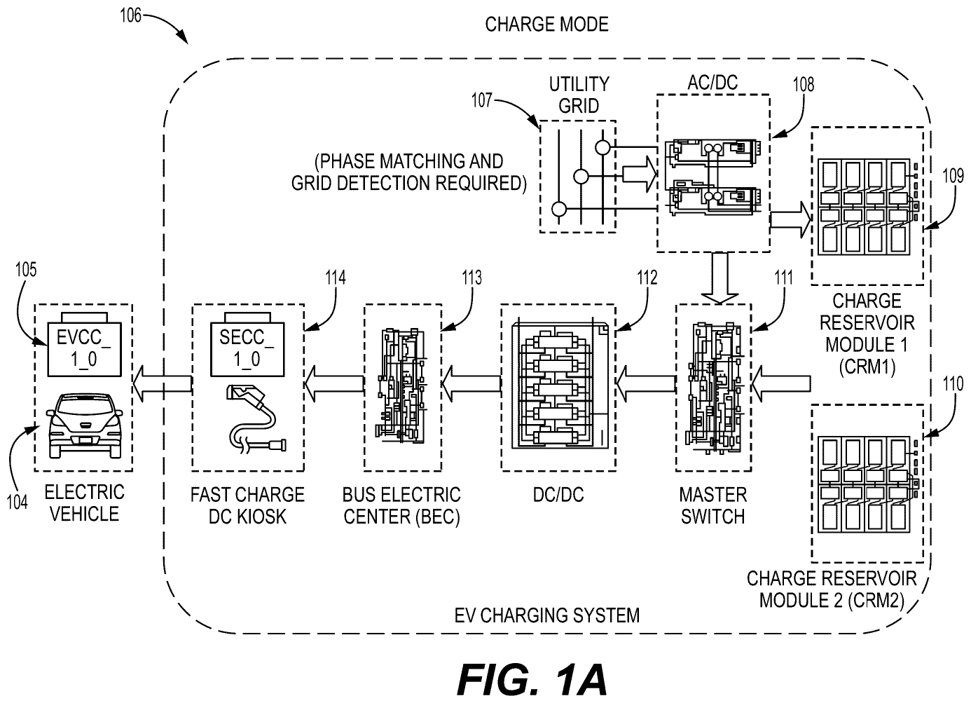

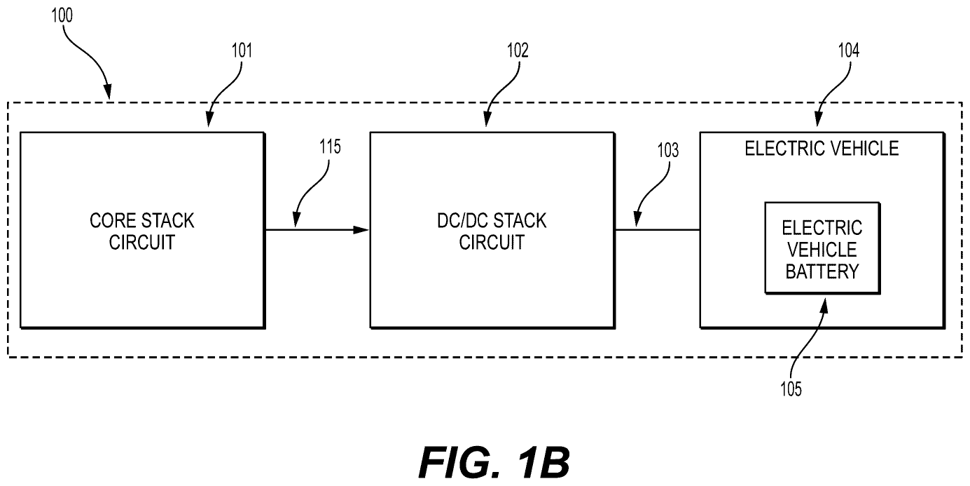

Charging systems, for example the charging system shown in FIG. 1A, are used to charge electric vehicles (EVs). Some battery packs within the EVs (e.g., high-voltage EV battery packs) require a relatively high charging voltage. Power reservoirs may be implemented within the charging systems to store power that is used to charge the EV battery packs, for example as disclosed in U.S. patent application Ser. No. 17/644,829, which is hereby incorporated by reference in its entirety. Power reservoirs may include, for example, flow batteries, lithium-ion batteries, power storage capacitors, fuel cells, and flywheels. The configuration of components within charging systems (e.g., the power reservoir) may be critical to the risk of single-point termination failures. Furthermore, the high charging voltage required by certain EV battery packs may result in increased equivalent series resistance (ESR) losses at termination points within the charging systems, which can lead to increased costs and inefficiency.

In single voltage and power-rated charging systems, the voltage level of the charging system must be bucked (e.g., stepped from a comparatively high voltage to a comparatively lower voltage) or boosted (e.g., stepped from a comparatively low voltage to a comparatively higher voltage) to approximately match the voltage requirements of a battery pack within the electric vehicle to which it is connected. Because charging systems may be used to charge electric vehicles having an array of differing charging voltages, the ability to buck or boost voltage levels is an important feature of charging systems. However, electrical conversion losses due to bucking and boosting in conventional charging systems can be significant.

Embodiments disclosed herein may reduce the risk of single-point termination failures by including a flow battery having analog termination of electrolyte fluids that route through a reactor core of the flow battery. Because the electrolyte fluids (e.g., anolyte and catholyte solutions) are separated until they make proximal contact with battery cells within the reactor core, there may be reduced risks in embodiments of the present disclosure compared with fully terminated lithium-ion battery arrays. Furthermore, embodiments disclosed herein may reduce the time required to re-charge the power reservoirs.

Systems and methods disclosed herein may include power reservoirs with increased charging capacities. For example, the charging capacities of embodiments disclosed herein may have charging capacities limited only by the size of a tank used to hold the electrolyte fluids. Furthermore, systems and methods disclosed herein may mitigate the need for charging systems to be in close spatial proximity to the electric vehicle it is charging. For example, utilizing electrolyte fluids within the charging systems may mitigate the need for a DC voltage link, thereby reducing the ESR losses. In addition, embodiments disclosed herein may eliminate the self-discharge that is present within conventional lithium-ion battery cells. Systems and methods disclosed herein may further provide throttleable control of the charging systems. For example, pumps may control the flow of the anolyte and catholyte solutions to reduce power losses between the flow battery and DC/DC converters.

Furthermore, systems and methods disclosed herein mitigate the losses due to bucking and boosting within a DC/DC converter and efficiently utilize the available power in a power reservoir (e.g., electrolyte tank) to transfer power to the EV battery pack. For example, systems and methods disclosed herein involve controlling voltage steps within the charging system by arrangements of components within the charging system. These arrangements may result in lower buck and boost ratios and may result in lower power conversion losses and increased efficiency in the transfer of electrical power to the electric vehicle. Furthermore, embodiments disclosed herein may result in a narrower voltage operating band that allows for using smaller or cheaper electrical components in the design and construction of the charging system. This can result in increased profits and reduced costs.

FIG. 1A depicts a diagram of an electric vehicle charging system coupled to a utility power grid, in accordance with some embodiments. In the example depicted in FIG. 1A, the electric vehicle charging system 106 is coupled to a utility power grid 107. The utility power grid 107 may generate alternating current (AC) power. The electric vehicle charging system 106 may include an AC/DC converter 108. The AC/DC converter 108 may be configured to phase-match the AC power received from the utility power grid 107 and convert the AC power to direct current (DC) power. The AC/DC converter 108 may be coupled to a first power reservoir 109, a second power reservoir 110, and a master switch 111. The first and second power reservoirs 109, 110, can be utilized to store DC power when they are not being used to charge an electric vehicle.

The master switch 111 may be used to transfer DC power from the first and second power reservoirs 109, 110 to a DC/DC converter 112. Additionally or alternatively, the master switch may be used to transfer DC power from the AC/DC converter 112 to the DC/DC converter 112, based on the power requirements and the use of the electric vehicle charging system 106. The DC/DC converter 112 may be used to buck or boost the DC power received from the master switch 111 to a DC/DC output voltage at an output side of the DC/DC converter 112. The DC/DC converter 112 may be coupled to a bus electric center (BEC) module 113. The BEC module 113 may provide a plurality of electrical components (e.g., fuses, relays, capacitors) in a single location. The BEC module 113 may transfer the power generated at the output side of the DC/DC converter 112 to an electric vehicle charger (e.g., a fast-charge DC kiosk) 114. The electric vehicle charger 114 may connect to and charge a battery 105 within an electric vehicle 104.

In embodiments, the power generated by the first and second power reservoirs 109, 110 may convert energy stored within an electrolyte (e.g., anolyte or catholyte) to electricity through an electrochemical conversion. The generated electricity can then be conditioned by the DC/DC converter 112 and controlled and supplied to the electric vehicle 104 through a scheduled charge profile. A limiting factor of the example embodiment depicted in FIG. 1A is that the power available from the utility power grid 107 and the capacity of the first and second power reservoirs 109, 110 can limit the service availability of the electric vehicle charging system 106. Furthermore, the example embodiment depicted in FIG. 1A may require the first and second power reservoirs 109, 110 to be in close spatial proximity to the electric vehicle charger 114 to mitigate electrical losses. In addition, the electric vehicle charging system 106 depicted in FIG. 1A can realize high buck and boost ratios within the DC/DC converter 112, which can result in inefficient power usage and increased costs. Embodiments of the present disclosure can increase the service availability of electric vehicle charging systems and allow a greater distance from power reservoirs to electric vehicle chargers. Moreover, embodiments of the present disclosure can include decreased buck and boost ratios of DC/DC converters within the electric vehicle charging systems, resulting in increased efficiency and reduced costs.

FIG. 1B depicts a diagram of an electric vehicle charging system, in accordance with some embodiments. In the example embodiment depicted in FIG. 1B, the electric vehicle charging system 100 includes a core stack circuit 101. The core stack circuit 101 may generate a core stack output voltage 115. The core stack output voltage 115 may be received at a DC/DC stack circuit 102. The DC/DC stack circuit 102 may increase or decrease (e.g., buck or boost) the core stack output voltage 115 to a DC/DC stack circuit output voltage. Furthermore, the DC/DC stack circuit 102 may condition (e.g., remove noise from) the core stack output voltage 115. The DC/DC stack circuit 102 may be coupled to an electric vehicle charger (e.g., an electric vehicle charging cord) 103. The electric vehicle charger 103 may be used to charge an electric vehicle battery 105 within an electric vehicle 104. The DC/DC stack circuit 102 may charge the electric vehicle battery 105 based on the DC/DC stack circuit output voltage.

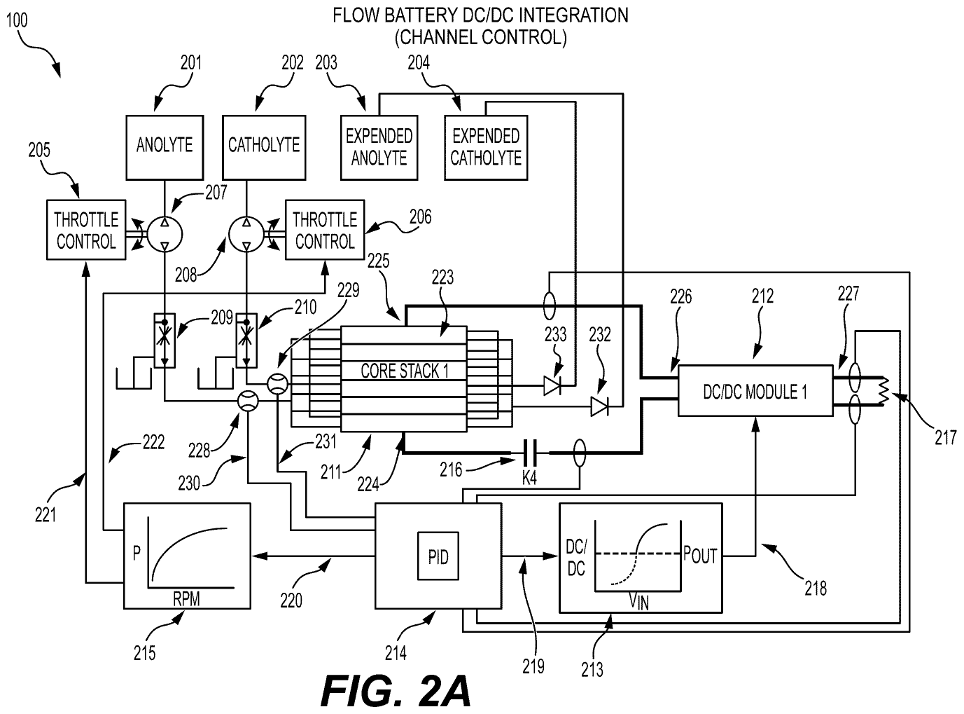

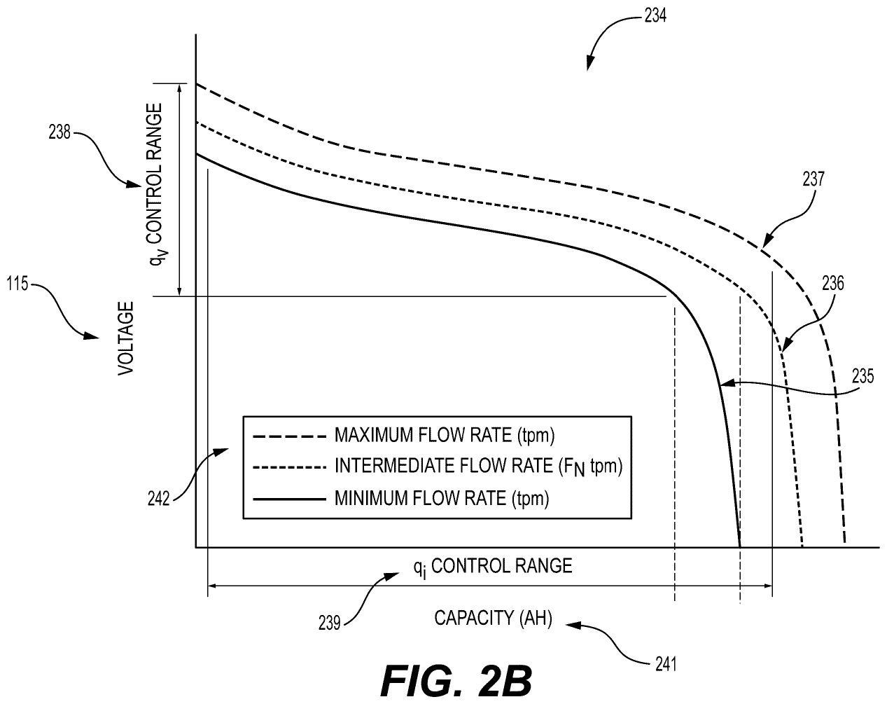

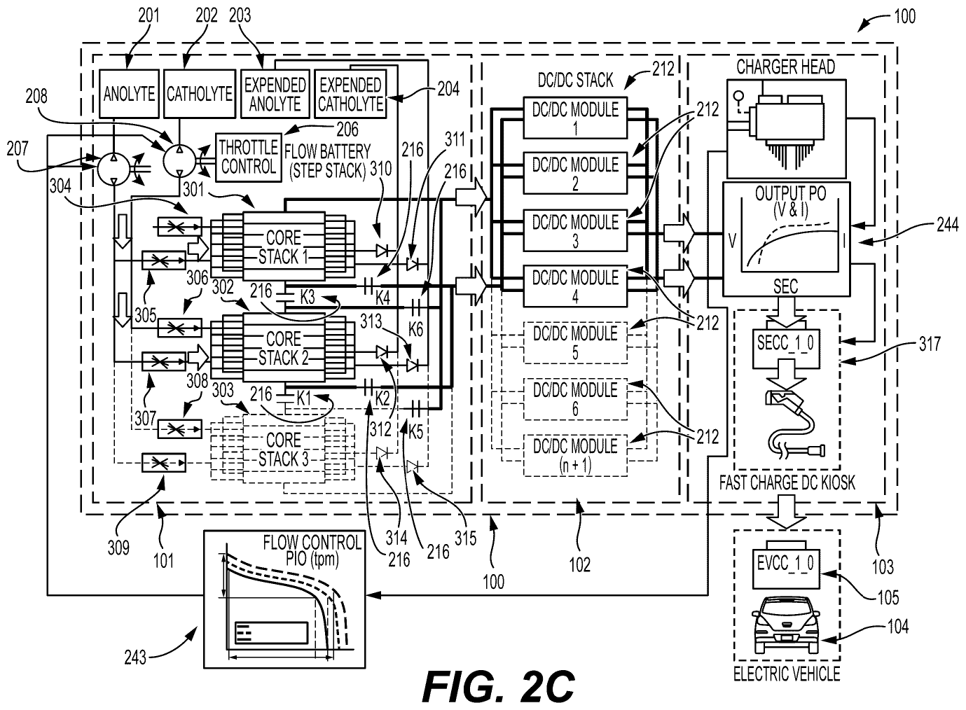

FIG. 2A depicts a detailed diagram of an electric vehicle charging system, in accordance with some embodiments. In the example depicted in FIG. 2A, the electric vehicle charging system 100 includes an anolyte tank (e.g., a positively charged electrolyte source tank) 201 containing an anolyte solution and a catholyte tank (e.g., a negatively charged electrolyte source tank) 202 containing a catholyte solution. The anolyte tank 201 may be coupled to a flow battery anolyte pump 207 and the catholyte tank 202 may be coupled to a flow battery catholyte pump 208. The flow battery anolyte pump 207 and the flow battery catholyte pump 208 may be, for example, variable speed controlled. The flow battery anolyte pump 207 may be coupled to and controlled by a first throttle control module 205. The flow battery catholyte pump 208 may be coupled to and controlled by a second throttle control module 206. In some example embodiments, both the flow battery anolyte pump 207 and the flow battery catholyte pump 208 may be controlled by a single throttle control module. The first throttle control module 205 may receive an anolyte control signal 221, and the second throttle control module 206 may receive a catholyte control signal 222. The first throttle control module 205 may control the rate at which the anolyte solution is pumped from the anolyte tank 201. The second throttle control module 205 may control the rate at which the catholyte solution is pumped from the catholyte tank 202.

The electric vehicle charging system 100 may further include a first variable flow control valve 209 and a second variable flow control valve 210. The first variable flow control valve 209 and the second variable flow control valve 210 may adjust the flow rate of the anolyte solution and the catholyte solution, respectively, based on changes in parameters such as temperature and load profile of the electric vehicle charging system 100. The electric vehicle charging system may further include a flow battery core stack 211 having a first end coupled to the first variable flow control valve 209 and the second variable flow control valve 210. The flow battery core stack 211 may include a plurality of flow battery cells 223 coupled to one another in series. Each flow battery cell 223 may have a nominal voltage of, for example, 3 volts. Each flow battery cell 223 may include a positive end and a negative end. The first variable flow control valve 209 may be configured to control the flow of the anolyte solution over the positive end of each flow battery cell 223 within the flow battery core stack 211. The second variable flow control valve 210 may be configured to control the flow of the catholyte solution over the negative end of each flow battery cell 223 within the flow battery core stack 211. By controlling the flow of anolyte and catholyte solutions over the positive and negative ends of the flow battery cells 223, an output voltage of the flow battery core stack can be controlled to a level within a core stack voltage variability range, as discussed further below.

The electric vehicle charging system 100 may further include an expended anolyte tank 203 and an expended catholyte tank 204. The expended anolyte tank 203 and the expended catholyte tank 204 may be coupled to a second end of the flow battery core stack 211. For example, the expended anolyte tank 203 may be coupled to the positive ends of the flow battery cells 223 at the second end of the flow battery core stack 211, and the expended catholyte tank 204 may be coupled to the negative ends of the flow battery cells 223 at the second end of the flow battery core stack 211. The flow battery core stack 211 may further include a positive terminal 224 and a negative terminal 225. The electric vehicle charging system 100 may further include a DC/DC converter module 212. The positive terminal 224 and negative terminal 225 of the flow battery core stack 211 may be coupled to an input end 226 of the DC/DC converter module 212. The DC/DC converter module 212 may further include an output end 227. The output end 227 may be coupled to a load (e.g., resistor) 217. In some example embodiments, the load 217 is a charging head of the electric vehicle charger 103 and is connected to the electric vehicle 104.

The electric vehicle charging system 100 may further comprise a control module (e.g., a proportional-integral-derivative (PID) control module) 214 and a power output module 213 coupled to the control module 214. The power output module 213 may be further coupled to the DC/DC converter module 212. The electric vehicle charging system 100 may further include a throttle power control module 215 coupled to the control module 214. The throttle power control module 215 may be further coupled to the first throttle control module 205 and the second throttle control module 206. The power output module 213, the control module 214, and the throttle power control module 215 may be, for example, implemented in software and executed by a system controller within or external from the electric vehicle charging system 100.

The anolyte solution may flow from the anolyte tank 201 through the flow battery anolyte pump 207 to the first variable flow control valve 209. The catholyte solution may flow from the catholyte tank 202 through the flow battery catholyte pump 208 to the second variable flow control valve 210. As described above, the first and second variable flow control valves 209, 210 may adjust the flow rate of the respective electrolyte fluids based on changes in parameters of the electric vehicle charging system 100 such as temperature and load profile. The anolyte solution may flow through an anolyte flow sensor (e.g., flow meter) 228 and the catholyte solution may flow through a catholyte flow sensor (e.g., flow meter) 229. The anolyte and catholyte solutions may then be received at the positive and negative ends, respectively, of the flow battery cells 223 within the flow battery core stack 211.

The flow battery anolyte pump 207 may receive the anolyte control signal 221 via the first throttle control module 205 from the control module 214 based on the power demands of the charging event. The flow battery catholyte pump 208 may receive the catholyte control signal 222 via the second throttle control module 206 from the control module 214. Based on the anolyte control signal 221, the flow battery anolyte pump 207 and the first variable flow control valve 209 may control the amount of anolyte solution received at the positive ends of the flow battery cells 223. Based on the catholyte control signal 222, the flow battery catholyte pump 208 and the second variable flow control valve 210 may control the amount of catholyte solution received at the negative ends of the flow battery cells 223.

For example, in a normal operation, the control module 214 may receive an anolyte flow sensor output signal 230 from the anolyte flow sensor 228 and a catholyte flow sensor output signal 231 from the catholyte flow sensor 229 containing time rate-of-change flowrate information for the anolyte and catholyte solutions, respectively. Based on the anolyte flow sensor output signal 230 and the catholyte flow sensor output signal 231, the control module 214 may determine that the voltage at the input end 226 of the DC/DC converter 212 should be increased. The control module 214 may then generate a throttle power control signal 220 indicating that the flow rate of the anolyte and catholyte solutions should be increased. The throttle power control signal 220 may be received by the throttle power control module 215. Based on the throttle power control signal 220, the throttle power control module 215 may generate the anolyte control signal 221 directing the first throttle control module 205 to increase the flow of the anolyte solution via the flow battery anolyte pump 207. Furthermore, the throttle power control module 215 may generate the catholyte control signal 222 directing the second throttle control module 206 to increase the flow of the catholyte solution via the flow battery catholyte pump 208. Thus, the throttle power control module 215 may work in conjunction with the control module 214 and the first and second throttle control modules 205, 206 to increase or decrease the flow of the anolyte and catholyte solutions.

Based on the anolyte flow sensor output signal 230 and the catholyte flow sensor output signal 231, the control module 214 may achieve closed-loop control of the anolyte and catholyte flow rate and thus allow an increased level of anolyte solution and catholyte solution to flow over the positive and negative ends of the flow battery cells 223. This increased flow of the anolyte solution and catholyte solution may cause an increase in the output voltage of the flow battery core stack 211, which is received at the input end 226 of the DC/DC converter module 212. However, this increase in the voltage received at the input end 226 of the DC/DC converter module 212 may be limited to not exceed a core stack voltage variability range. It may be necessary to connect additional flow battery core stacks (e.g., in a series configuration) to generate a voltage exceeding the core stack voltage variability range of a single flow battery core stack 211.

The output power of the flow battery core stack 211 may be a function of the intrinsic voltage of the individual flow battery cells 223, the area of the individual flow battery cells 223 that are in contact with the anolyte solution and the catholyte solution, and the flow rate of the anolyte solution and catholyte solution. For example, an increased flow rate of the catholyte and anolyte solutions may result in an increased output power of the flow battery core stack 211. After the anolyte solution flows over the positive ends of the flow battery cells 223, the anolyte solution may pass through an anolyte check valve 232 and accumulate in the expended anolyte tank 203. The anolyte check valve 232 may prevent anolyte solution from flowing backwards (e.g., from the expended anolyte tank 203 to the flow battery core stack 211). After the catholyte solution flows over the negative ends of the flow battery cells 223, the catholyte solution may pass through an a catholyte check valve 233 and accumulate in the expended catholyte tank 204. The catholyte check valve 233 may prevent catholyte solution from flowing backwards (e.g., from the expended catholyte tank 204 to the flow battery core stack 211).

The control module 214 may utilize a transfer function to adjust the flow of the anolyte and catholyte solutions based on the parameters of the DC/DC converter module 212 and the charging voltage of the electric vehicle it is charging. For example, the electric vehicle battery 105 within the electric vehicle 104 may require a relatively high charging voltage relative to the voltage at the input end 226 of the DC/DC converter module 212. The control module 214 may thus generate a throttle power control signal 220 indicating an increased flow of anolyte and catholyte solutions. It can be seen that the output of the flow battery core stack 211 may be controlled by means of the anolyte and catholyte control valve metering, the speed (rpm) of the flow battery anolyte and catholyte pump 207, 208 motors, or any combination of these devices. The maximum voltage of the flow battery core stack 211 may be a function of native electrical potentials of suspended particles within the respective anolyte and catholyte solutions. Furthermore, the maximum power of the flow battery core stack 211 may vary proportionally with the surface area of the flow battery cells 223.

Furthermore, the power output module 213 may be used to control the boost ratio or the buck ratio of the DC/DC converter module 212. For example, the DC/DC converter module 212 may work in conjunction with the control module 214 to minimize the buck ratio or boost ratio and thus minimize or reduce the ESR losses within the DC/DC converter module 212. The power output module 213 may be configured to select a particular buck ratio or boost ratio based on the voltage at the input end 226 of the DC/DC converter module 212 and the charging voltage of the electric vehicle battery 105. As described above, the flow battery core stack 211 comprises a plurality of single flow battery cells 223, each of which is capable of generating a nominal voltage (e.g., 3 volts) and are stacked in series to achieve a flow battery core stack output voltage (e.g., 18 volts for six (6) 3-volt single flow cells stacked in series). The core output power is developed as a function of the innate cell voltage, the cell planar area in contact with the electrolyte flow stream and the electrolyte flow rate (e.g., the anolyte flow rate and the catholyte flow rate). The control topology may be based on a closed loop PID control strategy in which a combination of pumps, flow control valves, source and return tanks, sensors and software produce a controlled power output as a converted (e.g., by the DC/DC converter module 212) form of an energy storage medium (e.g., the energy stored in the flow battery core stack 211).

FIG. 2B depicts an idealized flow battery parameter diagram, in accordance with some embodiments. FIG. 2B may be best understood when discussed in conjunction with FIGS. 1B and 2A. In the example shown in FIG. 2B, the idealized flow battery parameter diagram 234 shows a relationship between a core stack output voltage 115 of the core stack circuit 101 and a core stack output current 241 capacity of the core stack circuit 101 for a given flow rate of the anolyte and catholyte solutions. The idealized flow battery parameter diagram 234 may also represent, in some examples, a qualitative relationship between an output voltage of individual flow battery cells 223 and an output current of the individual flow battery cells 223 for a given flow rate of the anolyte and catholyte solutions. For example, an outer curve 237 may indicate the relationship between the core stack output voltage 115 and output current 241 of the core stack circuit 101 for a maximum flow rate. Connecting a particular number of flow battery core stacks 211 together (e.g., in a series configuration) may result in a particular core stack voltage variability range q_{V} 238 for such a configuration. Furthermore, for a particular core stack voltage variability range q_{V} 238 and particular instantaneous flow rates of the anolyte and catholyte solutions, the core stack circuit 101 may be capable of generating a particular core stack output current range qᵢ 239.

An optimized operating point having a core stack output voltage 115 and core stack output current 241 may be selected and generated by the core stack circuit 101. The optimized operating point may have a core stack output voltage 115 within the particular core stack voltage variability range q_{V} 238 and a core stack output current 241 within the core stack output current range qᵢ 239 of the configured core stack circuit. The optimized operating point may be selected to generate a power output (e.g., core stack output voltage 115×core stack output current 241) of the core stack circuit 101 that substantially matches a demand load of the charging apparatus (e.g., the electric vehicle charger 103). A dynamically controlled PID module (e.g., control module 214) may use a closed-loop feedback mechanism to determine the flow rates of anolyte and catholyte solutions necessary for the core stack circuit 101 to operate at the optimized operating point.

When the flow rate f_{V} of the anolyte and catholyte solutions are below a threshold flow rate f′ for a defined load condition, the voltage output of the respective flow battery cell 223 may vary as a function of flow rate f_{V} within a defined voltage range. Furthermore, when the flow rate f_{I} of the anolyte and catholyte solutions exceeds the threshold flow rate f′, the respective flow battery cells 223 may operate at or near a regulated maximum flow battery output voltage (as a function of the Nernst Equation). However, the power output of the flow battery cells 223 may continue to increase with increased flow rate based on an increased current output of the flow battery cells 223. The current output of the flow battery cells 223 may increase with the increased flow rate f_{I} until the power output of the flow battery cells 223 meets a design power limit of the flow battery cells 223. As disclosed herein, when the flow of the anolyte and catholyte solutions are below the threshold flow rate f′, the flow rate f_{V} may be used in conjunction with a “step control” based on variable configurations of a plurality of flow battery core stacks 211 to match or nearly match the input requirements of an attached component (e.g., the DC/DC converter module 212) by way of a trimming function.

The relationship between the threshold flow rate f′, the flow rate f_{V} below the threshold flow rate f′, and the flow rate f_{I} above the threshold flow rate f′ is comprehended in the active closed loop control scheme, which is implemented by the power output module 213, the control module 214, and the throttle power control module 215, as described further below. Based on the increased flow of the anolyte and catholyte solutions across the flow battery cells 223, the output voltage and/or current of the flow battery core stack 211 may vary. The variable output voltage and/or current may be received at the input end 226 of the DC/DC converter module 212. Thus, a lower boost ratio of the DC/DC converter module 212 may be required to increase the voltage from the input end 226 of the DC/DC converter module to the charging voltage of the electric vehicle battery. As discussed above, this can reduce ESR losses within the DC/DC converter module 212, leading to increased efficiency and reduced costs. Furthermore, lower buck and boost ratios can increase the time spent in linear regions by transistors within the electric vehicle charging system 100 and optimize gate charging voltages of the transistors.

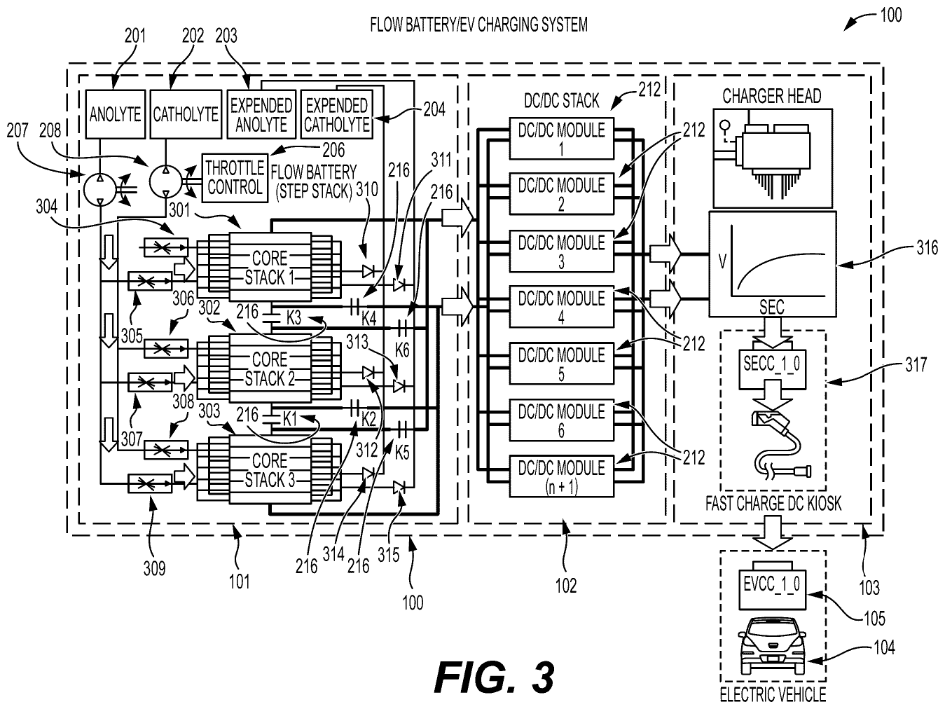

FIG. 2C depicts an electric vehicle charging system operating at a decreased current and voltage capacity, in accordance with some embodiments. In the example shown in FIG. 2C, the electric vehicle charging system 100 includes a core stack circuit 101 having a first flow battery core stack 301, a second flow battery core stack 302, and a third flow battery core stack 303. The DC/DC stack circuit 102 may comprise a plurality of DC/DC converter modules 212. The DC/DC stack circuit 102 may be coupled to an electric vehicle charging look-up table 244. An example embodiment of an electric vehicle charging system 100 having a core stack circuit 101 with a plurality of flow battery core stacks 301, 302, 303 and a DC/DC stack circuit 102 with a plurality of DC/DC converter modules 212 is further described in FIG. 3. The electric vehicle charging system 100 depicted in FIG. 2C may use a flow control PID module 243 that is coupled to the flow battery anolyte pump 207 and the flow battery catholyte pump 208. The flow control PID module 243 may utilize, for example, characteristics of the idealized flow battery diagram 234 depicted in FIG. 2B.

In the example shown in FIG. 2C, the electric vehicle 104 may make a voltage request and a charging request via a communication protocol used in the embodiment of the electric vehicle charging system 100 shown in FIG. 2C. The electric vehicle charging system 100 may be capable of selecting a particular configuration of the core stack circuit (e.g., connecting a particular number of flow battery core stacks 301, 302, 303 to each other) that nominally meets a voltage request made by the electric vehicle 104 plus an additional voltage allocation required for conditioning and control by the DC/DC stack circuit 102. Furthermore, the DC/DC stack circuit 102 may only employ (e.g., connect) a minimum number of DC/DC converter modules 212 required to meet the nominal electric vehicle charging system 100 output requirements and for optimal conditioning of the power output from the electric vehicle charging system 100 to the target electric vehicle 104. In the example shown in FIG. 2C, the first and second flow battery core stacks 301, 302 are active while the third flow battery core stack 303 is disconnected. Moreover, only four DC/DC converter modules 212 are active within the DC/DC stack circuit 102 while the remaining DC/DC converter modules 212 are disconnected. It should be understood that in other examples, more or fewer flow battery core stacks 301, 302, 303 or DC/DC converter modules 212 may be active based on, for example, charging requirements of the electric vehicle 104.

The flow control PID module 243 may use a PID function for “trim voltage” control within the core stack voltage variability range to gain control at a finer resolution of the voltage and current input (and thus power) received at the input end of the DC/DC converter modules 212. This “trim voltage” range of control may be directly operated by finely controlling the flow rate of the anolyte and catholyte solutions to the active flow battery core stacks of the core stack circuit 101. For example, the flow rate of the anolyte and catholyte solutions may be finely controlled, within a controllability range of the flow battery anolyte pump 207, the flow battery catholyte pump 208, and other components of the core stack circuit 101, to deliver a voltage and current input to the DC/DC converter modules 212 that substantially matches the voltage and current required by the electric vehicle 104. Additionally, the DC/DC stack circuit 102 may reference the electric vehicle charging look-up table 244 to achieve the optimized operating point discussed in reference to FIG. 2B.

Such flow rate tuning of the anolyte and catholyte solutions and power matching into the DC/DC stack circuit 102 may result in optimal efficiency of the electric vehicle charging system 100 by reducing the input-to-output ratio (e.g., turn-down ratio) of the DC/DC converter modules 212. Additionally, by configuring a step-voltage of the core stack circuit 101 by connecting or disconnecting participating flow battery core stacks based on the requested voltage of the electric vehicle 104 and further tuning through the “trim voltage” control of the anolyte and catholyte flow rates, the power electronics required by the DC/DC converter modules 212 can be managed to lower voltage steps. This may result in a significantly reduced cost and economic advantages to the electric vehicle charging system 100.

Furthermore, the flow battery core stacks 301, 302, 303 and the DC/DC converter modules 212 may be reconfigured throughout a charging event to optimally match instantaneous charging demands of the electric vehicle 104 so that losses of the electric vehicle charging system 100 are minimized. This may further minimize flow requirements and conversion losses of the electric vehicle charging system 100 and result in more efficient uses of components within the core stack circuit 101 (e.g., anolyte and catholyte electrolyte components). In a fully realized control regimen, it may be possible to operate in certain regions of a charge profile of the electric vehicle charging system 100 in which the DC/DC stack circuit 102 operates in a substantially idle state, and the power transfer to the electric vehicle 104 is a direct exchange between the flow battery core stacks 301, 302, 303 and the energy storage system of the electric vehicle 104 (e.g., the electric vehicle battery 105).

FIG. 3 depicts an electric vehicle charging system having a plurality of flow battery core stacks and a plurality of DC/DC converter modules, in accordance with some embodiments. In the example embodiment depicted in FIG. 3, the core stack circuit 101 includes a first flow battery core stack 301, a second flow battery core stack 302, and a third flow battery core stack 303. In some example embodiments, more or fewer flow battery core stacks may be used. The first flow battery core stack 301, the second flow battery core stack 302, and the third flow battery core stack 303 may be coupled to one another in series.

The flow battery core stacks 301, 302, 303 may be separated from one another by relays 216. Furthermore, each separate flow battery core stack 301, 302, 303 may have separate first and second variable flow control valves. A single flow battery anolyte pump 207 may be coupled to each first variable flow control valve 305, 307, 309. A single flow battery catholyte pump 208 may be coupled to each second variable flow control valve 304, 306, 308. The second and third flow battery core stacks 302, 303 may be connected or disconnected to the DC/DC stack circuit 102 through relays 216. For example, a controller (e.g., the control module 214) may selectively couple the second and third flow battery core stacks 302, 303 to the DC/DC stack circuit 102 based on the required input voltage of the DC/DC stack circuit 102. The selective coupling of the flow battery core stacks 301, 302, 303 to one another may coarsely tune the charging voltage of the electric vehicle 104.

The DC/DC stack circuit 102 may comprise a plurality of DC/DC converter modules 212. Each DC/DC converter module 212 may include a plurality of flow battery cells 223 connected to one another in series, as described above. Each DC/DC converter module 212 may be coupled to one another in parallel. Furthermore, each DC/DC converter module 212 may be selectively coupled in parallel with the remaining DC/DC converter modules 212 based on the required buck ratio or boost ratio of the flow battery output voltage to the charging voltage of the electric vehicle 104. For example, the power output module 213 may be used to connect or disconnect the DC/DC converter modules 212 to the parallel configuration to control the boost ratio or the buck ratio of the DC/DC stack circuit 102. The DC/DC stack circuit 102 may reference an electric vehicle charging look-up table 316 to determine the required output power of the DC/DC stack circuit 102 based on a particular charging speed. For example, a user may select a particular charging speed. Based on the selected charging speed, the electric vehicle charging look-up table 316 may indicate that a higher voltage is necessary to charge the electric vehicle battery 105. The DC/DC stack circuit 102 may be used to finely tune the charging voltage of the electric vehicle. The electric vehicle charger 103 may be coupled to the DC/DC stack circuit 102 and may connect to and charge the electric vehicle battery 105 of the electric vehicle 104.

As described above, FIG. 3 depicts an example of an electric vehicle charging system that utilizes a core stack circuit as an energy input source. The flow battery may convert energy stored within the anolyte and catholyte solutions into electricity by way of a core reactor. The specific voltage and current capability of a given flow battery core stack may be determined by the area of the individual flow battery cells and the number of flow battery cells connected in series. Furthermore, the flow battery core stacks may be arranged as series configurable such that the flow battery core stacks can be voltage matched to the specific nominal requirements of the DC/DC converter module 212 for a scheduled charge profile. This core configurability can result in a reduced bucking range requirement of the DC/DC converter module 212 and can allow for lower power component requirements. This can provide an economic advantage in the market.

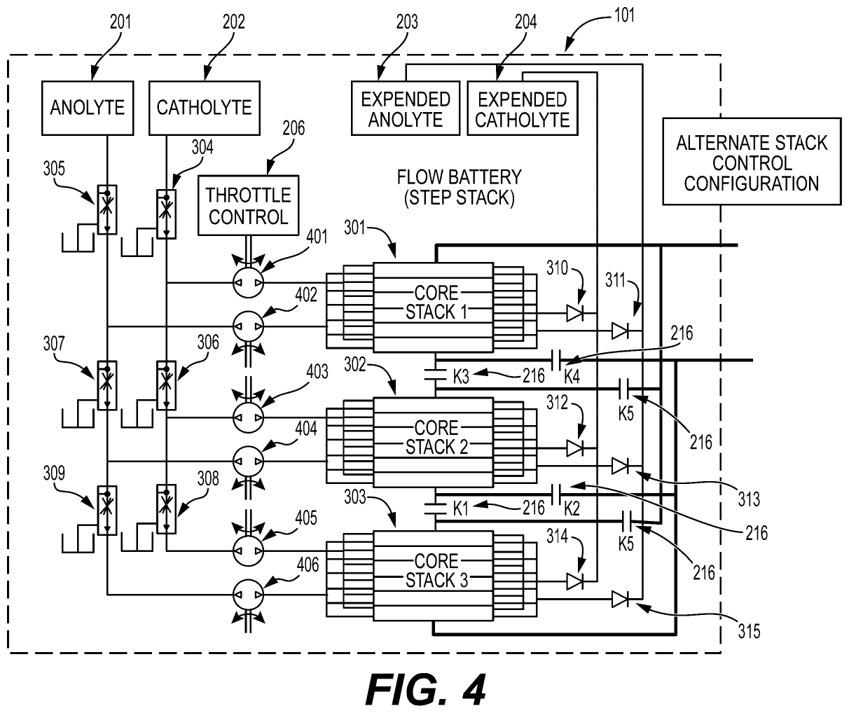

FIG. 4 depicts an example core stack circuit, in accordance with some embodiments. In the example depicted in FIG. 4, the core stack circuit 101 includes a dedicated first variable flow control valve 305, 307, 309 for each separate flow battery core stack 301, 302, 303. Furthermore, the core stack circuit 101 may include a dedicated second variable flow control valve 304, 306, 308 for each separate flow battery core stack 301, 302, 303. In addition or alternatively, the core stack circuit 101 may include a separate flow battery anolyte pump 402, 404, 406 and a separate flow battery catholyte pump 401, 403, 405 for each separate flow battery core stack 301, 302, 303.

The pump control (e.g., anolyte and catholyte flow rate) may be used as a power trimming function between the flow battery core and the DC/DC converter module 212 depending on the mechanical mechanization selected for any given leg of the example core stack circuit 101. The flow battery may be controlled so that it can nearly provide direct battery charge profile management. This can allow for power electronics devices with reduced performance ratings to be used in the construction of the DC/DC power conditioning hardware.

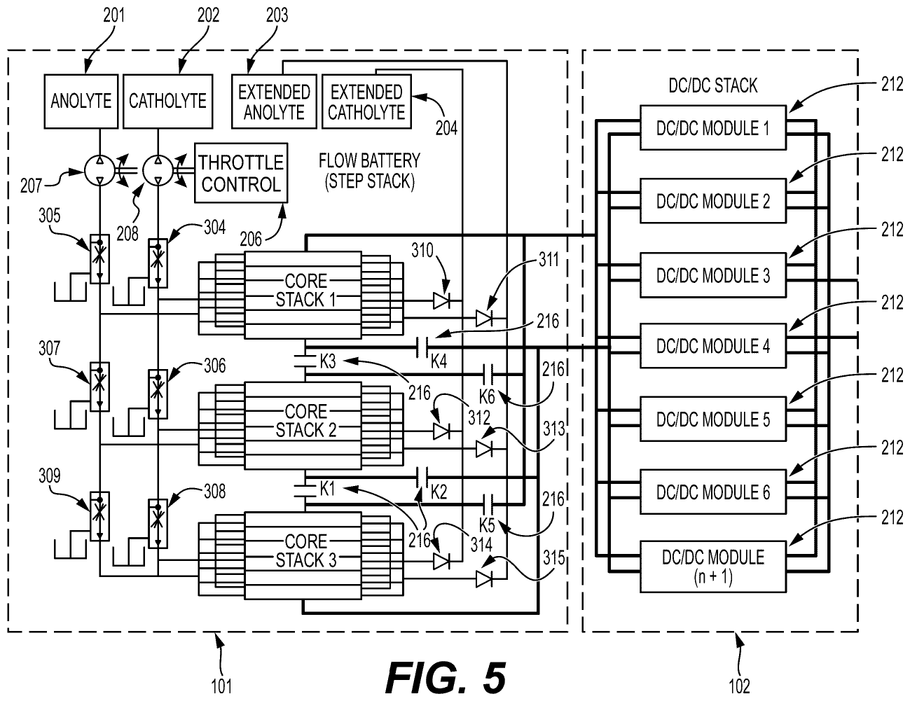

FIG. 5 depicts a core stack circuit and a DC/DC stack circuit, in accordance with some embodiments. The example embodiment depicted in FIG. 5 may be similar to the example core stack circuit 101 and the DC/DC stack circuit 102 depicted in FIG. 3.

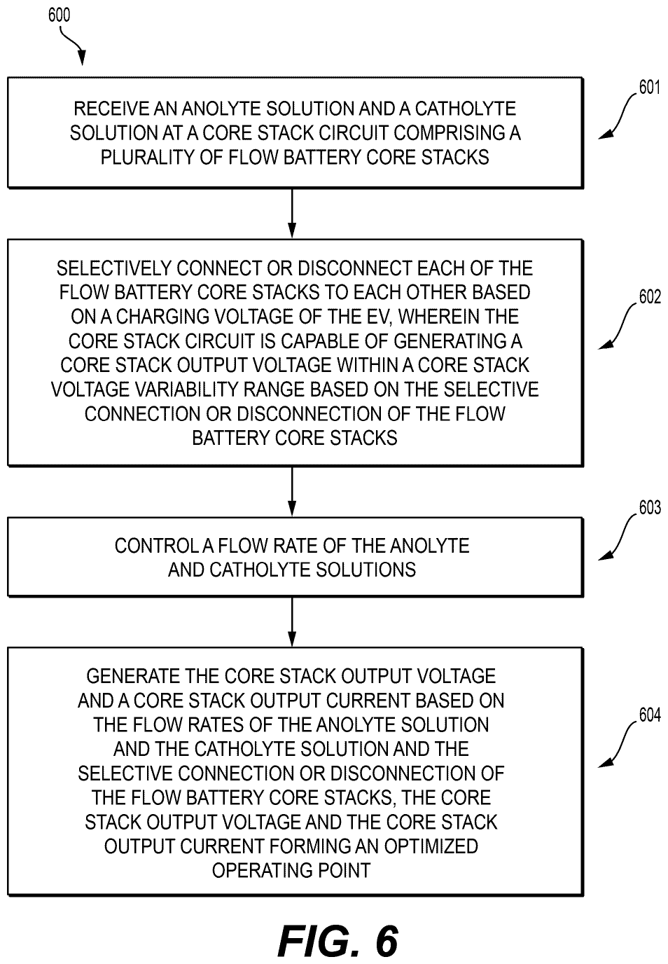

FIG. 6 depicts a method of charging an EV, in accordance with some embodiments. In the example shown in FIG. 6, the method 600 includes a first step 601 of receiving an anolyte solution and a catholyte solution at a core stack circuit comprising a plurality of flow battery core stacks. The method 600 may include a second step 602 of selectively connecting or disconnecting each of the flow battery core stacks to each other based on a charging voltage of the EV. The core stack circuit may be capable of generating a core stack output voltage within a core stack voltage variability range based on the selective connection or disconnection of the flow battery core stacks. The method 600 may include a third step 603 of controlling a flow rate of the anolyte and catholyte solutions. The method 600 may include a fourth step 604 of generating the core stack output voltage and a core stack output current based on the flow rates of the anolyte solution and the catholyte solution and the selective connection or disconnection of the flow battery core stacks. The core stack output voltage and the core stack output current may form an optimized operating point.

As described above, power matching may be exemplified as a grouping of selectable channels or groupings of flow battery core apparatuses and DC/DC converter apparatuses. The power and voltage needs of the configured system are selectable based on the voltage requirements of the scheduled charge profile. The ability to select the voltage step (e.g., the number of flow battery core stacks in the series configuration) may reduce the turn-down ratio required on the DC/DC converter module 212, which significantly reduces conversion power losses and reduces power device ratings (e.g., switch size) needed to perform conversion operations. The DC/DC conversion equipment may be substantially equivalently modular and selectable for optimal power matching and load sharing to reduce power losses of the system. The anolyte and catholyte solutions utilized by the charging system are conserved. Therefore, the usage of the stored energy is maximized.

It will be appreciated by those skilled in the art that changes could be made to the embodiments described above without departing from the broad inventive concept thereof. It is understood, therefore, that the invention disclosed herein is not limited to the particular embodiments disclosed, and is intended to cover modifications within the spirit and scope of the present invention.

What is claimed is:

1. An electric vehicle (EV) charging system comprising:
an electrolyte flow system including an anolyte tank having an anolyte solution and a catholyte tank having a catholyte solution, the EV charging system configured to control a flow rate of the anolyte solution and the catholyte solution;
a core stack circuit coupled to the electrolyte flow system, the core stack circuit comprising a plurality of flow battery core stacks, the core stack circuit configured to receive the anolyte solution and the catholyte solution and to generate a flow battery core stack output voltage and current based on the flow rates of the anolyte solution and the catholyte solution, each flow battery core stack selectively connected or disconnected to one another, the selective connection or disconnection of each flow battery core stack coarsely tuning an EV charging voltage; and
a DC/DC converter module comprising a plurality of DC/DC converters, the DC/DC converter module coupled to the core stack circuit and configured to receive the flow battery core stack output voltage and current, the DC/DC converter module further configured to buck or boost the flow battery core stack output voltage based on the flow battery core stack output voltage and the EV charging voltage, the bucking or boosting of the flow battery core stack output voltage finely tuning the EV charging voltage.

2. The EV charging system of claim 1, wherein each flow battery core stack comprises a plurality of flow battery cells connected together in series.

3. The EV charging system of claim 1, wherein each of the DC/DC converters is selectively coupled to one another in parallel based on a buck ratio or a boost ratio of the DC/DC converter module.

4. The EV charging system of claim 3, wherein the EV charging system is configured to charge the EV at one of a plurality of charging speeds, wherein the buck ratio or the boost ratio is determined based on a selected charging speed of the EV charging system.

5. The EV charging system of claim 1, further comprising a control module configured to selectively connect one or more flow battery core stacks to one another based on a required input voltage of the DC/DC converter module.

6. The EV charging system of claim 5, further comprising one or more relays coupled to the control module, wherein the control module selectively connects the one or more flow battery core stacks to one another based on opening or closing the one or more relays.

7. An electric vehicle (EV) charging system comprising:
an electrolyte flow system including an anolyte tank having an anolyte solution and a catholyte tank having a catholyte solution;
a core stack circuit coupled to the electrolyte flow system, the core stack circuit configured to receive the anolyte solution and the catholyte solution and to generate a core stack output voltage and current based on a flow rate of the anolyte solution and a flow rate of the catholyte solution; and
a DC/DC converter coupled to the core stack circuit, the DC/DC converter configured to receive the core stack output voltage and to buck or boost the core stack output voltage based on the core stack output voltage and a charging voltage of an EV, the EV charging system configured to control the flow rates of the anolyte solution and the catholyte solution based on a charging voltage of the EV and the core stack output voltage, the controlling of the flow rates reducing a buck ratio or a boost ratio of the DC/DC converter.

8. The EV charging system of claim 7, wherein the core stack circuit comprises a plurality of flow battery cells connected together in series.

9. The EV charging system of claim 8, wherein the core stack circuit receives the anolyte solution at a positive end of each flow battery cell and the catholyte solution at a negative end of each flow battery cell.

10. The EV charging system of claim 7, wherein the core stack circuit comprises a plurality of flow battery core stacks, wherein the EV charging system is configured to connect or disconnect each of the flow battery core stacks to each other based on the charging voltage of the EV.

11. The EV charging system of claim 7, further comprising a power output module coupled to the DC/DC converter, the power output module configured to control the boost ratio or the buck ratio of the DC/DC converter.

12. The EV charging system of claim 11, further comprising a throttle power control module coupled to the electrolyte flow system, the throttle power control module configured to control the flow rate of the anolyte solution and the flow rate of the catholyte solution.

13. The EV charging system of claim 12, further comprising a control module coupled to the power output module and the throttle power control module, the control module configured to adjust the flow rate of the anolyte solution and the catholyte solution based on one or more parameters of the DC/DC converter and the charging voltage of the EV.

14. A method of charging an electric vehicle (EV) comprising:
receiving an anolyte solution and a catholyte solution at a core stack circuit comprising a plurality of flow battery core stacks;
selectively connecting or disconnecting each of the flow battery core stacks to each other based on a charging voltage of the EV, wherein the core stack circuit is capable of generating a core stack output voltage within a core stack voltage variability range based on the selective connection or disconnection of the flow battery core stacks;
controlling a flow rate of the anolyte and catholyte solutions; and
generating the core stack output voltage and a core stack output current based on the flow rates of the anolyte solution and the catholyte solution and the selective connection or disconnection of the flow battery core stacks, the core stack output voltage and the core stack output current forming an optimized operating point.

15. The method of claim 14, further comprising bucking or boosting the core stack output voltage based on the core stack output voltage and the charging voltage of the EV.

16. The method of claim 15, wherein the control of the flow rates of the anolyte and catholyte solution are determined by a proportional-integral-derivative (PID) controller.

17. The method of claim 16, wherein the EV includes a plurality of charging speeds, wherein the method further includes controlling a charging current of the EV based on a selected one of the plurality of charging speeds.

18. The method of claim 17, further comprising referencing a look-up table to determine the charging voltage of the EV based on the selected charging speed of the EV.

19. The method of claim 14, further comprising accumulating the anolyte solution and the catholyte solution after the anolyte solution and the catholyte solution are used to charge the EV.

20. The method of claim 14, wherein the selective connection and disconnection of each of the flow battery core stacks is further based on an additional voltage allocation required for conditioning and control by a DC/DC converter module.
